(19) United States
(12) Patent Application Publication
(10) Pub. No.: US 2010/0079588 A1
(43) Pub. Date: Apr. 1, 2010

(54) IMAGE PROCESSING APPARATUS, METHOD, AND COMPUTER READABLE MEDIUM

(75) Inventors: Takashi MUROOKA, Kanagawa (JP); Hideyasu Ishibashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/569,820

(22) Filed: Sep. 29, 2009

(30) Foreign Application Priority Data
Sep. 30, 2008 (JP) 2008-255567

(51) Int. Cl. H04N 7/18

(52) U.S. Cl. 348/68; 348/E07.085

(57) ABSTRACT

Provided is an image processing apparatus comprising a recording section that records information identifying diseases in association with polarization characteristics of disease positions having a disease; an image acquiring section that acquires a polarized image captured at an observed position by an endoscope, the polarized image being captured using light having a plurality of different polarization states; a determining section that determines the disease by comparing (i) the polarization characteristic of the observed position acquired from the polarized image to (ii) the polarization characteristics recorded in the recording section; and a notification section that notifies a user with information specifying the disease determined by the determining section.

The present application claims priority from a Japanese Patent Application No. 2008-255567 filed on Sep. 30, 2008.

### BACKGROUND

1. Technical Field

The present invention relates to an image processing apparatus, a method, and a computer readable medium.

2. Related Art

Japanese Patent Application Publication No. 10-165357 discloses a technique for enabling a user to judge whether an uneven portion is present by shadows generated from light emitted to be diagonally incident to the uneven portion.

With the technology disclosed in JP 10-165357, the user makes a judgment concerning the uneven portion based on the shadows alone, and therefore, when attempting to identify a type of disease represented by the uneven portion, only an experienced user would be able to make an appropriate judgment.

### SUMMARY

Therefore, it is an object of an aspect of the innovations herein to provide an unevenness detecting apparatus, a method, and a computer readable medium, which is capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary image processing apparatus may comprise a recording section that records information identifying diseases in association with polarization characteristics of disease positions having a disease; an image acquiring section that acquires a polarized image captured at an observed position by an endoscope, the polarized image being captured using light having a plurality of different polarization states; a determining section that determines the disease by comparing (i) the polarization characteristic of the observed position acquired from the polarized image to (ii) the polarization characteristics recorded in the recording section; and a notification section that notifies a user with information specifying the disease determined by the determining section.

According to a second aspect related to the innovations herein, one exemplary system may comprise the image processing apparatus according to the first aspect; and an endoscope apparatus. The endoscope apparatus includes a first irradiating section that radiates light to the observed position; and an image capturing section that captures an image using returned light obtained as a reflection of the light radiated by the first irradiating section, the returned light including light polarized in directions orthogonal to each other. The image acquiring section acquires the polarized image captured by the image capturing section, and the determining section determines the disease by comparing (i) the polarization characteristic of the observed position obtained from the polarized image to (ii) the polarization characteristics recorded in the recording section.

According to a third aspect related to the innovations herein, one exemplary method may include a method for image processing using a computer that is provided with a recording section that records information identifying diseases in association with polarization characteristics of disease positions having a disease, the method comprising acquiring a polarized image captured at an observed position by an endoscope, the polarized image being captured using light having a plurality of different polarization states; determining the disease by comparing (i) the polarization characteristic of the observed position acquired from the polarized image to (ii) the polarization characteristics recorded in the recording section; and notifying a user with information specifying the determined disease.

According to a third aspect related to the innovations herein, one exemplary computer readable medium may include a computer readable medium storing thereon a program for use by a computer provided with a recording section that records information identifying diseases in association with polarization characteristics of disease positions having a disease, the program, when executed, causing the computer to function as an image acquiring section that acquires a polarized image captured at an observed position by an endoscope, the polarized image being captured using light having a plurality of different polarization states; a determining section that determines the disease by comparing (i) the polarization characteristic of the observed position acquired from the polarized image to (ii) the polarization characteristics recorded in the recording section; and a notification section that notifies a user with information specifying the disease determined by the determining section.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary system according to an embodiment of the present invention.

FIG. 2 shows an exemplary configuration of the shape identifying section 203.

FIG. 3 shows examples of the light emitted from the first irradiating section 102 and the second irradiating section 103, and light-dark states resulting from the light emitted by the second irradiating section 103.

FIG. 4 shows an exemplary table stored by the recording section 205.

FIG. 5 shows an exemplary tip 121 of the scope 101 according to the first modification.

FIG. 6 shows an exemplary unevenness detecting method according to the second modification.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

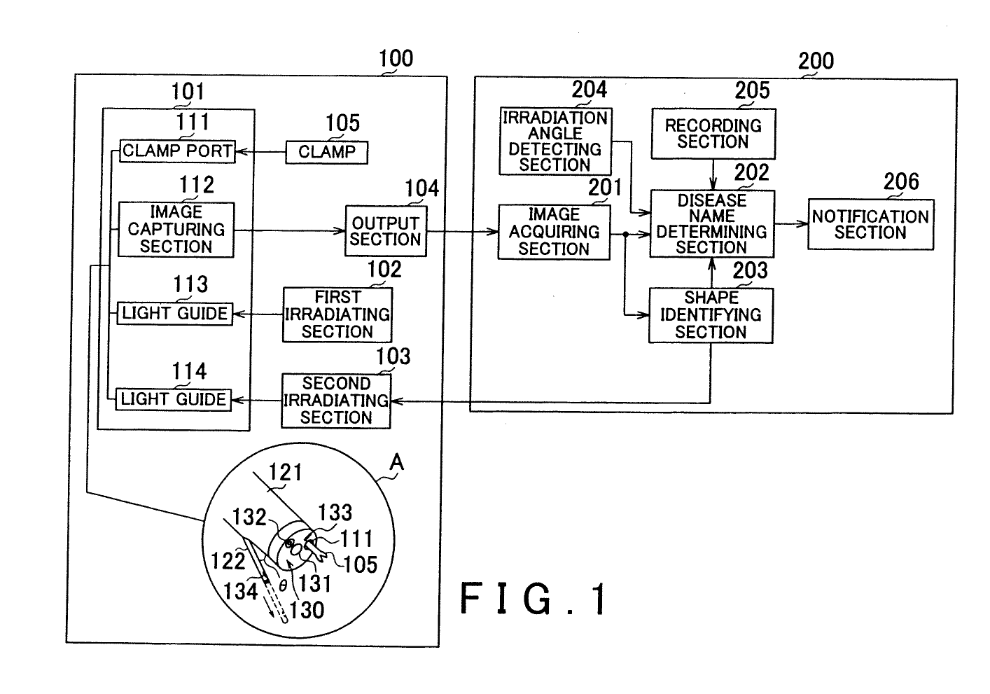

FIG. 1 shows an exemplary configuration of a system according to an embodiment of the present invention. The system includes an endoscope apparatus 100 and an image processing apparatus 200. The endoscope apparatus 100 includes a scope 101, a first irradiating section 102, a second irradiating section 103, an output section 104, and a clamp 105. In FIG. 1, section “A” shows an enlarged view of a tip 121 of the scope 101. The image processing apparatus 200 includes an image acquiring section 201, a disease name determining section 202, a shape identifying section 203, an irradiation angle detecting section 204, a recording section 205, and a notification section 206.

The scope 101 includes a clamp port 111, an image capturing section 112, a light guide 113, and a light guide 114. The tip 121 of the scope 101 includes a lens 131 as a portion of the image capturing section 112 on a tip surface 130 thereof. The tip 121 includes an irradiation aperture 132 as a portion of the light guide 113 on the tip surface 130 thereof. The light guide 114 is a portion of the scope 101, and the tip of the light guide 114 is provided inside a separable section 122 that can be separated from the tip 121 of the scope 101.

One end of the separable section 122 is rotatably mounted on the tip 121 of the scope 101, and the other end of the separable section 122 has the irradiation aperture 134 as a portion of the light guide 114. The separable section 122 has the irradiation aperture 134 on a side surface thereof. The separable section 122 is provided with the irradiation aperture 134 such that light emitted from the second irradiating section 103 is radiated toward the tip 121 of the scope 101. The separable section 122 is usually in a closed state, that is, a state in which the angle between the separable section 122 and the tip 121 is 0 degrees. FIG. 1 shows an open angle between the separable section 122 and the tip 121. As shown by the dotted line in FIG. 1, the separable section 122 is extendable.

The first irradiating section 102 generates the light emitted from the tip 121 of the scope 101. The first irradiating section 102 includes a light source for generating the light. The light guide 113 may be made of optical fiber, for example. The light guide 113 guides the light emitted from the first irradiating section 102 to the tip 121 of the scope 101. The light generated by the first irradiating section 102 is emitted from the irradiation aperture 132. The first irradiating section 102 generates circularly polarized light. The first irradiating section 102 can generate circularly polarized light by providing a polarization filter that passes circularly polarized light on the light source side of the first irradiating section 102. The light guide 113 maintains the polarized state of the light generated by the first irradiating section 102 to emit circularly polarized light from the irradiation aperture 132. Instead, the first irradiating section 102 may generate non-polarized light and a circular polarization filter that passes circularly polarized light may be provided to the irradiation aperture 132, so that the irradiation aperture 132 emits circularly polarized light. The polarization filter may be removed from the path of the light from the light source, so that the first irradiating section 102 radiates non-polarized light.

The second irradiating section 103 generates the light emitted from the separable section 122 of the scope 101. The second irradiating section 103 includes a light source for generating the light. The light guide 114 may be made of optical fiber, for example. The light guide 114 guides the light emitted from the second irradiating section 103 to the separable section 122 of the scope 101. The light generated by the second irradiating section 103 is emitted from the irradiation aperture 134. The second irradiating section 103 controls the opening angle of the separable section 122. The second irradiating section 103 also controls the length of the separable section 122. More specifically, the separable section 122 includes a motor for changing the opening angle, and the second irradiating section 103 includes a motor control section for controlling this motor. Accordingly, this motor control section controls the opening angle. The separable section 122 has a structure that allows for length extension, and includes a motor for changing the length. The second irradiating section 103 includes a motor control section that controls this motor. The motor control section may be formed from an information processing apparatus such as a CPU. In this way, the second irradiating section 103 can irradiate the uneven portion with light that is diagonally incident thereto.

A clamp 105 is inserted into the clamp port 111, and the clamp port 111 guides the clamp 105 to the tip 121. The clamp 105 may be shaped as any type of tip. In addition to the clamp 105, various other tools for performing processes on an organism may be inserted into the clamp port 111. The nozzle 133 ejects water or air.

The image capturing section 112 includes an image capturing element and an optical system. The optical system includes the lens 131 and a polarizing section. The polarizing section includes a plurality of first polarization filters and second polarization filters, which linearly polarize light in directions orthogonal to each other. These first and second polarization filters are arranged in a lattice formation. The polarizing section may also include polarization filters with a polarization direction different from the linear polarization of the first and second polarization filters. The first and second polarization filters may be provided to correspond respectively to pixels in the image capturing element. In other words, the light passing through one polarization filter may be received by one pixel. The image capturing element captures an image based on the light passed by the polarizing section. The image capturing section 112 also includes an image capturing element driver for driving the image capturing element, an AD converter, and the like. The image captured by the image capturing element is read by the image capturing element driver and converted into a digital signal by the AD converter. Here, the image captured by the image capturing element via the polarization filter is called the “polarized image.” The output section 104 outputs the polarized image captured by the image capturing section 112 to the image acquiring section 201 of the image processing apparatus 200. Here, unless specified otherwise, it is assumed that the image capturing section 112 captures an image of the observed position from a prescribed angle. In the following description, this prescribed angle is an angle of 90 degrees relative to observed position, that is, the image capturing section 112 captures an image of the observed position from directly in above.

The image acquiring section 201 acquires the polarized image captured by the image capturing section 112 and sent from the output section 104. The image acquiring section 201 outputs the acquired polarized image to the disease name determining section 202 and the shape identifying section 203. The image acquiring section 201 outputs the polarized image captured based on the irradiated circularly polarized light to at least the shape identifying section 203. The shape identifying section 203 identifies the shape of the uneven portion at the observed position based on the received polarized image.

The irradiation angle detecting section 204 detects an irradiation angle relative to the surface of the observed position that is irradiated when the polarized image is captured. The irradiation angle detecting section 204 may include a gyrosensor provided to the tip of the scope 101, and may detect the irradiation angle by using the gyrosensor to detect how much the angle has changed from the 90-degree angle at the time of image capturing perpendicular to the observed position. For example, the first irradiating section 102 radiates light from the tip surface 130 of the tip 121 of the scope 101, and so when light is radiated by the first irradiating section 102, the angle detected by the gyrosensor is the irradiation angle. When light is radiated by the second irradiating section 103, the irradiation angle detecting section 204 detects the irradiation angle based on the angle detected by the gyrosensor with reference to the length and opening angle of the separable section 122. The current angle for the irradiation angle detecting section 204 is set at 90 degrees by instructions from a user when the image capturing surface is perpendicular to the observed position.

The recording section 205 stores a table in which is recorded disease names in association with polarization characteristics of a disease position, a shape of the disease position, the irradiation angle with which these polarization characteristics are achieved, and the like. Here, the polarized image of the disease position is stored as one example of a polarization characteristic. The polarization characteristic is known based on the polarized image. In the following description, the stored polarized image of the disease position is referred to as the “polarized reference image.” The disease name determining section 202 determines the name of the disease at the captured observed position by comparing (i) the polarized image acquired from the image acquiring section 201 to (ii) the polarized reference image stored in the recording section 205 that corresponds to the shape detected by the shape identifying section 203 and the irradiation angle detected by the irradiation angle detecting section 204. The notification section 206 notifies the user of the disease name determined by the disease name determining section 202. The notification section 206 may notify the user by speaking the disease name, or by displaying the disease name. The notification section 206 may display the polarized reference image corresponding to the determined disease name. The disease name is one example of information indicating a disease. In the present embodiment, the information indicating the disease may also include information specifying the type of disease. The information indicating the disease may include information specifying at least one of a level, a degree of progression, and a phase of the disease. The information indicating the disease may include the information specifying at least one of a level of the disease, a degree of progression, and a phase in addition to the information specifying the type of disease.

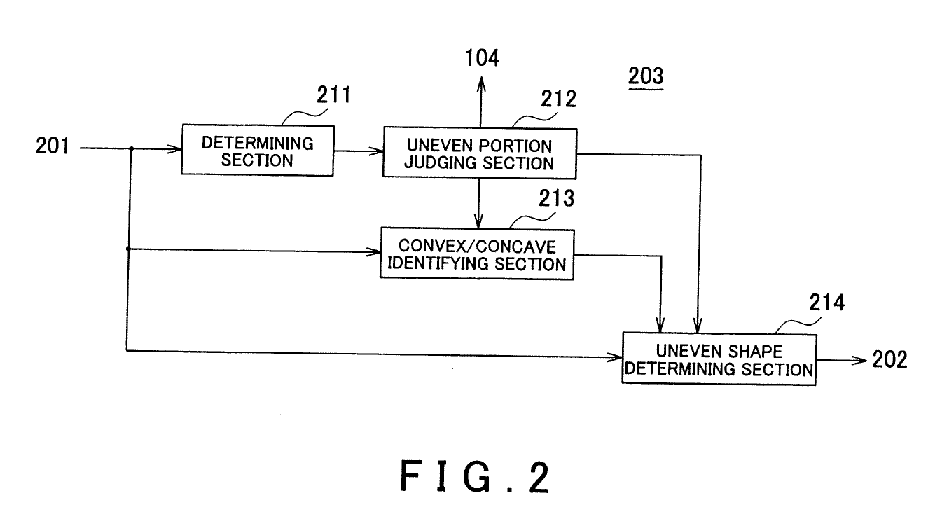

FIG. 2 shows an exemplary configuration of the shape identifying section 203. The shape identifying section 203 includes a determining section 211, an uneven portion judging section 212, a convex/concave identifying section 213, and an uneven shape determining section 214. The determining section 211 determines the polarization state of the returned light resulting from the emitted circularly polarized light being reflected, based on the polarized image received from the image acquiring section 201. More specifically, the determining section 211 determines the polarization state based on a ratio between the amount of light passed by the first polarization filter and the amount of light passed by the second polarization filter. In other words, the determining section 211 determines the polarization state based on a ratio between (i) a charge amount of the light passed by the first polarization filter and captured by the image capturing element and (ii) a charge amount of the light passed by the second polarization filter and captured by the image capturing element. The determining section 211 determines the polarization state for the returned light from each of a plurality of regions.

Here, when the angle of incidence of the circularly polarized light is 90 degrees, the returned light becomes circularly polarized light. When the angle of incidence is not 90 degrees, the returned light becomes elliptically polarized light. The smaller the angle of incidence of the circularly polarized light, the greater the ellipticity of the elliptically polarized returned light. Accordingly, the polarization state of the returned light can be determined using the first and second polarization filters having polarization directions orthogonal to each other. For example, when the amount of light passed by the first polarization filter is equal to the amount of light passed by the second polarization filter, the polarization state of the returned light is circular. On the other hand, when the amount of light passed by the first polarization filter is not equal to the amount of light passed by the second polarization filter, the polarization state of the returned light is elliptical. The greater the difference between the amount of light passed by the first polarization filter and the amount of light passed by the second polarization filter, the greater the ellipticity of the elliptically polarized returned light.

The uneven portion judging section 212 judges whether there is an uneven portion based on the polarization state of the returned light determined by the determining section 211. For example, when there is an uneven portion in an otherwise flat surface and light is radiated to the flat portion and the uneven portion in a manner such that the light is circularly polarized when perpendicularly incident to the flat portion, the polarization state of the returned light reflected by the flat portion is circular and the polarization state of the returned light reflected by the uneven portion is elliptical. Therefore, the uneven portion judging section 212 judges that an uneven portion is present in this region. When there is an uneven portion in an otherwise flat surface and light is radiated to the flat portion and the uneven portion in a manner such that the light is circularly polarized when incident to the flat portion at an acute angle, the returned light reflected by the flat portion has a certain elliptical polarization and the returned light reflected by the uneven portion has a different elliptical polarization. In other words, a range over which regions are gathered having returned light with substantially identical polarization states is judged to be flat, and a region for which the polarization state of the returned light differs from that of the returned light from a flat region is judged to contain an uneven portion. Here, an “uneven portion” refers to a portion with a depressed portion or with a protruding portion.

Since the angle of the incident light relative to the surface is known by the polarization state of the returned light from each region, regions containing an uneven portion may be judged based on the overall angle of incidence for the regions. In other words, a range over which regions are gathered having substantially identical angles of incidence is judged to be flat, and a region for which the angle of incidence differs from that of the flat region is judged to contain an uneven portion. The conversion from the polarization state of the returned light to the angle of incidence can be achieved by preparing in advance in a table associating the polarization state with the angle of incidence, and using this table to perform the conversion. The conversion from the polarization state of the returned light to the angle of incidence may instead be performed by calculating the angle of incidence based on the polarization state. The uneven portion judging section 212 outputs, to the uneven shape determining section 214, the angle of incidence for each region judged to contain an uneven portion.

Since a flat region can be determined based on the polarization state of the returned light from the region or the angle of incidence of the light in the region, the angle of incidence of a flat region becomes the irradiation angle of the first irradiating section 102. Accordingly, the irradiation angle detecting section 204 may detect the irradiation angle to be the angle of incidence of a flat region determined based on the judgment by the uneven portion judging section 212. In this case, the gyrosensor need not be provided, thereby simplifying the structure. Of course the irradiation angle of the second irradiating section 103 is known based on the length and opening angle of the second irradiating section 103, in the same manner.

Since the polarization state of each region of the observed position is known, the degree of unevenness of a region judged to have an uneven portion is also known. Furthermore, since the angle of incidence of each region of the observed position is known, the degree of unevenness of a region judged to have an uneven portion is also known. The degree of unevenness represents the degree to which the surface protrudes or recedes. The uneven portion judging section 212 outputs, to the second irradiating section 103, the degree of unevenness of a region that is judged to have an uneven portion. The uneven portion judging section 212 outputs the region judged to be the uneven portion to the convex/concave identifying section 213.

The second irradiating section 103 irradiates the uneven portion with light at an angle according to the degree of unevenness of the uneven portion as judged by the uneven portion judging section 212. The angle according to the degree of unevenness is a relative measurement using the angle of incidence relative to a flat portion as a standard. In other words, the opening angle and length of the separable section 122 are controlled based on the unevenness of the region judged to be uneven by the uneven portion judging section 212, in order to diagonally irradiate this uneven portion with light. The second irradiating section 103 may store the table in which is recorded the length and opening angle corresponding to the degree of unevenness, and control the length and opening angle of the separable section 122 based on the degree of unevenness received from the uneven portion judging section 212. The second irradiating section 103 may instead calculate the length and opening angle of the separable section 122 based on the degree of unevenness received from the uneven portion judging section 212, and control the length and opening angle to be the calculated values. The image capturing section 112 captures an image based on the returned light resulting from the second irradiating section 103 diagonally radiating light to the portion judged to be uneven by the uneven portion judging section 212, and the captured image is then sent via the image acquiring section 201 to the convex/concave identifying section 213. At this time, the image capturing may be performed with the polarizing section provided to the image capturing element being removed from the path of the light incident to the image capturing element. In this case, the polarizing section of the image capturing section 112 is configured to be able to move from the path of the light. In this way, non-polarized light is incident to the image capturing element.

The convex/concave identifying section 213 identifies whether the portion judged to be uneven by the uneven portion judging section 212 is convex or concave, based on the image captured when the second irradiating section 103 diagonally radiates light to the uneven portion. More specifically, the convex/concave identifying section 213 identifies whether the uneven portion is convex or concave based on a light-dark state of the uneven portion in the image. The convex/concave identifying section 213 can make this identification because the formation of shadows is different for a concave portion than for a convex portion when diagonally irradiated with light. The convex/concave identifying section 213 outputs the convex or concave identification to the uneven shape determining section 214. The uneven shape determining section 214 determines the shape of the uneven portion based on each angle of incidence of in the uneven portion received from the uneven portion judging section 212 and the convex or concave identification received from the convex/concave identifying section 213. The uneven shape determining section 214 outputs the determined shape of the uneven portion to the disease name determining section 202.

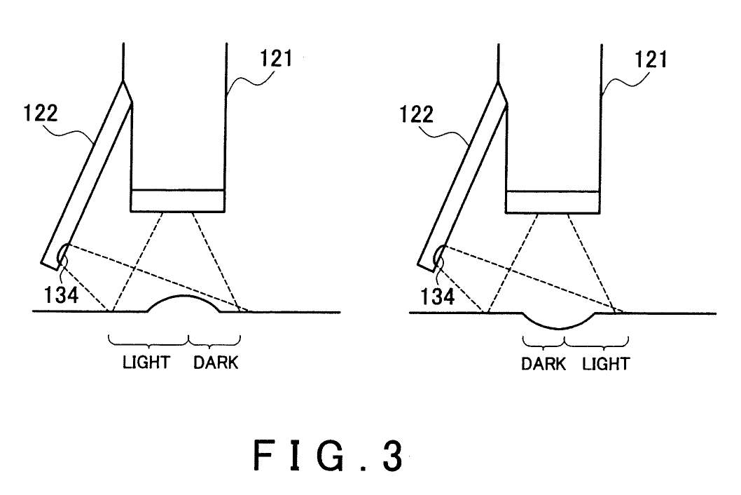

FIG. 3 shows examples of the light emitted from the first irradiating section 102 and the second irradiating section 103, and light-dark states resulting from the light emitted by the second irradiating section 103. The drawing on the left side of FIG. 3 shows an exemplary light-dark state resulting from light radiated to an observed position that has a convex portion. The drawing on the right side of FIG. 3 shows an exemplary light-dark state resulting from light radiated to an observed position that has a concave portion. Here, the determining section 211 determines the polarization state of the returned light based on the image captured by the image capturing section 112 using the returned light obtained as the reflection of circularly polarized light emitted by the first irradiating section 102. The uneven portion judging section 212 determines the polarization state of the returned light based on the image captured by the image capturing section 112 using the returned light determined by the determining section 211 to have circular polarization.

However, since the polarization state only changes depending on the angle of incidence of the light to the observed position, a judgment can be made based on the polarization state as to whether there is an uneven portion, but it cannot be ascertained whether this uneven portion is convex or concave. That is, by simply radiating circularly polarized light, the returned light for the convex portion and the returned light for the concave portion shown in FIG. 3 have the same polarization state, and both are therefore judged to have the same inclination angle. To solve this problem, the second irradiating section 103 radiates light diagonally to the portion judged to be uneven to create shadows, so that a judgment can be made as to whether the uneven portion is convex or concave based on the light and dark portions of the image.

The convex or concave identification may indicate a convex portion when a portion closer to the irradiation aperture 134 of the separable section 122 is light and a portion further from the irradiation aperture 134 is dark. The convex or concave identification may indicate a concave portion when a portion closer to the irradiation aperture 134 of the separable section 122 is dark and a portion further from the irradiation aperture 134 is light.

Depending on the form of the recess or protrusion in the uneven portion, it might be impossible to create shadows merely by radiating the light diagonally. For example, in the case of a very small recess or protrusion, shadows might not be formed if the light has an angle of incidence of approximately 45 degrees. As another example, in the case of a very large recess or protrusion, radiating the light to have an angle of incidence of approximately 25 degrees might result in the shadowy region being too large, which is unsuitable for the judgment. To solve this problem, the second irradiating section 103 changes the length and opening angle of the separable section 122 to diagonally radiate light at an angle according to the degree of unevenness of the portion judged to be uneven by the uneven portion judging section 212, so that an image with suitable light and dark portions can be obtained.

When the second irradiating section 103 radiates light and the image capturing section 112 captures the image used by the convex/concave identifying section 213 to judge whether the uneven portion is convex or concave, the first irradiating section 102 need not radiate light. When the image capturing section 112 captures the image used by the convex/concave identifying section 213 to judge whether the uneven portion is convex or concave, the first irradiating section 102 may radiate less light than the second irradiating section 103. As a result, it is easier to form shadows in the uneven portion.

After the convex/concave identifying section 213 judges whether the uneven portion is convex or concave, the second irradiating section 103 may stop radiating light. In this case, the first irradiating section 102 radiates light. Instead of stopping light radiation, the second irradiating section 103 may radiate less light than the first irradiating section 102. Causing the irradiating section 104 to radiate less or no light is beneficial because it prevents the shadows formed on the uneven portion from becoming too weak, which would cause precise observation to become more difficult. When the uneven portion judging section 212 judges whether an uneven portion is present, the first irradiating section 102 may radiate non-polarized light. As an example of a configuration for radiating polarized and non-polarized light, the light source in the first irradiating section 102 may be provided with a polarization filter that passes circularly polarized light. The polarizing filter may positioned in the path of the light emitted by the light source to generate circularly polarized light, and may be removed from the path of the light emitted by the light source to generate non-polarized light.

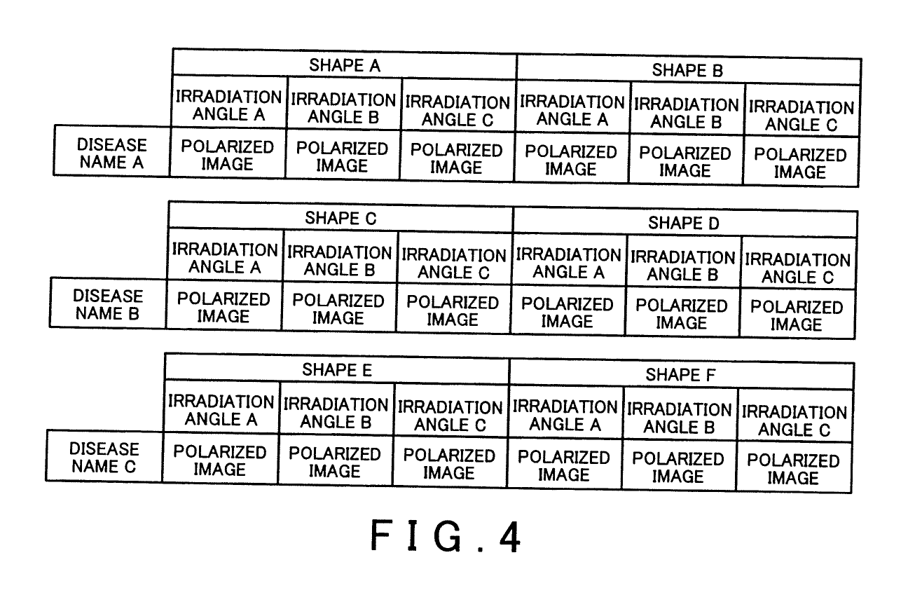

FIG. 4 shows an exemplary table stored by the recording section 205. In this table, polarized reference images of a disease position are stored for each disease name. Irradiation angles relative to the irradiated surface at the time of capturing the polarized reference images are stored in association with the polarized reference images. Shapes of the disease position are stored in association with the polarized reference images captured at these disease positions. In other words, for each recorded disease name, a polarized reference image at a disease position is recorded for various irradiation angles and shapes of the disease position. For example, in the case of disease name A, a polarized reference image at a disease position is recorded for irradiation angles A, B, and C when the disease position has a shape A, and for irradiation angles A, B, and C when the disease position has a shape B. Here, even for the same disease, there are different shapes for the disease position of this disease, and these shapes correspond to different degrees of progression or the like of the disease. Therefore, polarized reference images showing a plurality of different shapes are recorded for each disease. Since the polarized image depends on the angle of incidence of the light, polarized reference images captured at a plurality of different angles of incidence are recorded for each disease.

The disease name determining section 202 selects the appropriate polarized reference image from the recording section based on the irradiation angle received from the irradiation angle detecting section 204 and the shape received from the shape identifying section 203. The disease name determining section 202 may select a polarized reference image that corresponds to an irradiation angle matching the irradiation value received from the irradiation angle detecting section 204, with a certain amount of allowable difference between the irradiation angles. The disease name determining section 202 may select a polarized reference image that corresponds to a shape matching the shape received from the shape identifying section 203, with a certain amount of allowable difference between the shapes. The disease name determining section 202 may select a polarized reference image that corresponds to a shape matching the shape received from the shape identifying section 203 and to an angle of incidence matching the angle of incidence received from the irradiation angle detecting section 204, with a certain amount of allowable difference between the shapes and angles of incidence. The disease name determining section 202 may select a polarized reference image that corresponds to a shape and an angle of incidence whose average degree of matching with regard to the shape received from the shape identifying section 203 and the angle of incidence received from the irradiation angle detecting section 204 is greater than a prescribed value. The disease name determining section 202 compares the selected polarized reference image to the polarized image received from the image acquiring section 201. The disease name determining section 202 determines a disease name that corresponds to a sufficiently matching polarized reference image to be the disease name for the observed position received from the image acquiring section 201. The disease name determining section 202 outputs this disease name to the notification section 206.

Here, when the polarized reference images recorded in the recording section 205 are images captured using the returned light that is a reflection of radiated circularly polarized light, the image acquiring section 201 may output, to the disease name determining section 202, polarized images captured using the returned light that is a reflection of radiated circularly polarized light. When the polarized reference images recorded in the recording section 205 are images captured using the returned light that is a reflection of radiated non-polarized light, the image acquiring section 201 may output, to the disease name determining section 202, polarized images captured using the returned light that is a reflection of radiated circularly polarized light. The polarized images output to the disease name determining section 202 by the image acquiring section 201 may be images captured using the returned light that is a reflection of the light radiated by the first irradiating section 102, or may be images captured using the returned light that is a reflection of the light radiated by the second irradiating section 103. The polarized images output to the disease name determining section 202 by the image acquiring section 201 may be images captured based on light radiated from either the first irradiating section 102 or the second irradiating section 103. This is beneficial because the polarization characteristics of the polarized images change when light is radiated from a plurality of angles.

The notification section 206 notifies the user concerning the disease name determined by the disease name determining section 202. The notification section 206 may include a speaker, and may notify the user of the determined disease name using a voice. The notification section 206 may have a display, and may show the determined disease name to the user. The notification section 206 may display the polarized reference image corresponding to the determined disease name.

In this way, the present embodiment can radiate circularly polarized light from the first irradiating section 102, judge whether an uneven portion is present based on the polarization state of the returned light, and obtain the angle of incidence of the light relative to the uneven portion. The present embodiment can then identify whether the uneven portion is convex or concave by radiating light from the second irradiating section 103 to be diagonally incident to the region determined to contain the uneven portion. The present embodiment then determines the shape of the uneven portion based on the angle of incidence relative to the uneven portion and the information indicating whether the uneven portion is convex or concave. The present embodiment detects the irradiation angle at the time when the polarized image of the uneven portion is captured. The present embodiment selects a polarized reference image recorded in the table based on the uneven portion and the irradiation angle, and determines the name of the disease by comparing the polarized image of the uneven portion to the selected polarized reference image. Accordingly, the present embodiment can accurately determine what disease symptom is represented by the uneven portion. Each component of the endoscope apparatus 100 and each component of the image processing apparatus 200 described in the present embodiment is controlled by an information processing apparatus such as a CPU or by a computer. The disease name determining section 202 and the shape identifying section 203 may be realized as an electronic circuit, or may be realized as an information processing apparatus such as a CPU. The irradiation angle detecting section 204 and the notification section 206 may be realized using an information processing apparatus.

The embodiment described above may be modified in the following ways.

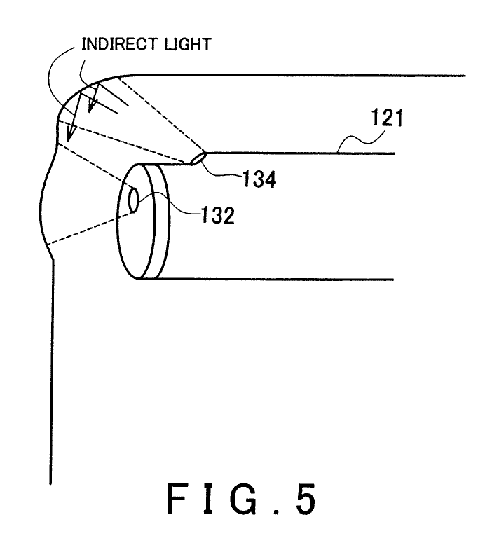

(1) In a first modification, the second irradiating section 103 may emit light from a side of the tip 121 of the scope 101, without providing the separable section 122. FIG. 5 shows an exemplary tip 121 of the scope 101 according to the first modification. The side of the tip 121 is provided with an irradiation aperture 134 that emits the light generated by the second irradiating section 103. The tip surface 130 of the tip 121 is provided with the irradiation aperture 132 that emits the light generated by the first irradiating section 102, in the same manner as the above embodiments. In FIG. 5, the lens 131, the clamp port 111 and the nozzle 133 are not shown. By providing the irradiation aperture 134 on the side of the tip 121, the light emitted from the irradiation aperture 134 directly hits a subject and is then reflected, and so the indirect light, which is light emitted by the second irradiating section 103 and reflected, diagonally irradiates an indirect position. In this way, shadows can be generated in the uneven portion using a simpler structure, which lowers the manufacturing cost.

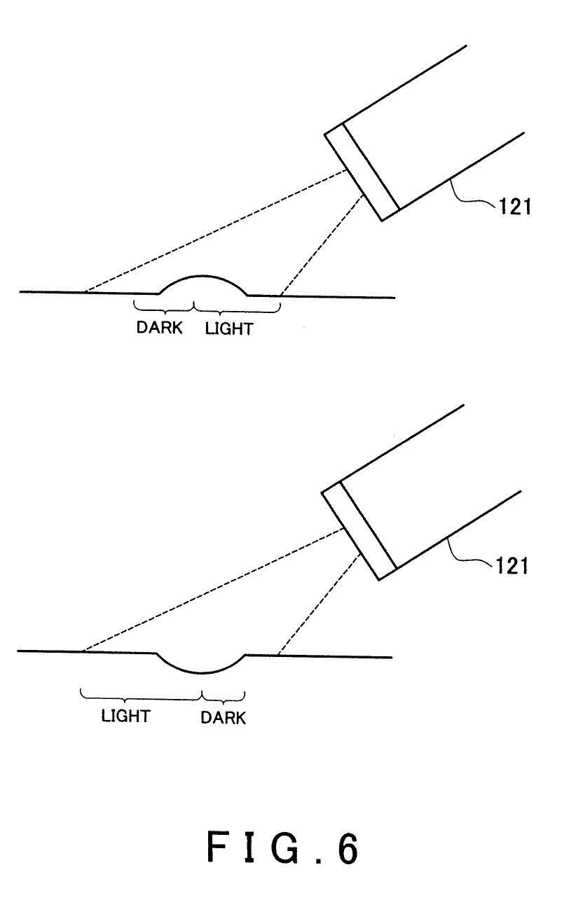

(2) A second modification is not provided with the separable section 122 or the second irradiating section 103. FIG. 6 shows an exemplary unevenness detecting method according to the second modification. As shown in FIG. 6, the tip 121 of the scope 101 is slanted relative to the observed position, so that the light emitted by the first irradiating section 102 is diagonally incident to the observed position. In this way, shadows can be generated on the uneven portion without providing the second irradiating section 103. Here, the first irradiating section 102 radiates light diagonally to the observed position, and so returned light from a flat portion of the observed position, that is, a portion that is not uneven, is circularly polarized. The uneven portion judging section 212 can judge the presence of an uneven portion in a region based on the polarization state of all of the returned light. In other words, the uneven portion judging section 212 can judge an uneven portion to be present in a region having a different polarization state based on the polarization state of all of the returned light.

(3) A third modification addresses a problem that, when the area of the uneven portion irradiated with light by the second irradiating section 103 is small relative to the total area of the uneven portion, it is difficult to identify whether the uneven portion is convex or concave based on a single image captured using light irradiating a certain position. The third modification may move the irradiated position, capture a plurality of images at different irradiated positions, and use the plurality of images to identify whether the uneven portion is convex or concave. In other words, the irradiated position, which the position in the observed position at which the second irradiating section 103 radiates light, is moved, and the convex/concave identification is then made based on the light-dark state in a plurality of images captured at different irradiated positions. When the area of the uneven portion irradiated with light by the first irradiating section 102 is small relative to the total area of the uneven portion, it is difficult to identify whether the uneven portion is convex or concave based on a single image captured using light irradiating a certain position. Therefore, the third modification moves the irradiated position and identifies whether the uneven portion is convex or concave based on a plurality of images captured at different irradiated positions.

(4) In a fourth modification, only the disease name and the polarized reference image of a disease position corresponding to this disease name need be recorded in the table stored in the recording section 205. In this case, the disease name is determined by comparing the captured polarized image to the polarized reference images. In the table, one of either the irradiation angle or the shape may be recorded in association with the polarized reference image. For example, when a disease name, a polarized reference image, and an irradiation angle are recorded in association in the table, the irradiation angle at the time when the polarized image of the observed position is captured is detected, and the polarized image is compared with a polarized reference image that corresponds to the irradiation angle matching the detected irradiation angle, with a certain difference allowable between the angles. In this case, the first irradiating section 102 need not have a configuration for radiating circularly polarized light. Furthermore, there need be only one irradiating section. If a disease name, a polarized reference image, and a shape are recorded in association in the table, the polarized image is compared to the polarized reference image corresponding to the shape of the observed position. In this case, the irradiation angle detecting section 204 need not be provided.

(5) In the above modifications, the shape identifying section 203 is provided on the image processing apparatus 200 side, but in a fifth modification, the shape identifying section 203 may be provided on the endoscope apparatus 100 side. In the same way, in the above modifications, the irradiation angle detecting section 204 is provided on the image processing apparatus 200 side, but in the fifth modification, the irradiation angle detecting section 204 may be provided on the endoscope apparatus 100 side.

(6) In the above modifications, the image capturing section 112 captures the image of the observed position at a fixed angle, but in a sixth modification, this angle is variable. In this case, the irradiation angle may be fixed when the polarized image is captured. When the irradiation angle is fixed, polarized images for each image capturing angle are recorded in the table of the recording section 205 in place of the polarized images for each irradiation angle. Both the image capturing angle of the image capturing section 112 and the irradiation angle at the time of capture may be changed. When the irradiation angle and the image capturing angle change, the polarization characteristics also change, and so, in this case, polarized images corresponding respectively to each irradiation angle and image capturing angle are recorded in the table of the recording section 205. A gyrosensor may be used to detect the image capturing angle. Another detection method may be used instead.

(7) In a seventh modification, the convex/concave identifying section 213 need not be provided. In this case, the uneven portion judging section 212 detects the uneven portion, and also detects the angle of incidence for each region having an uneven portion. A comparison is then made between (i) the angle of incidence for each uneven portion and (ii) a polarized reference image that corresponds to an approximately matching shape. It is unknown, based on the angle of incidence of the light in each uneven portion, whether the inclination is a protrusion or a depression, but by just knowing the angle of inclination, the shape can be known to a certain extent.

(8) In the above modifications, the first irradiating section 102 radiates circularly polarized light, but in an eight modification, the first irradiating section 102 may radiate light with different polarization. In other words, the first irradiating section 102 may radiate any one type of light from among non-polarized light, elliptically polarized light, and linearly polarized light. The uneven portion judging section 212 may determine whether an uneven portion is present based on the polarization state of the returned light obtained as a reflection of the light radiated by the first irradiating section 102. That is, the uneven portion judging section 212 may determine whether an uneven portion is present based on the polarization state of the returned light obtained as a reflection of the non-polarized light, elliptically polarized light, or linearly polarized light radiated by the first irradiating section 102.

(9) A ninth modification may be any combination of the first through eighth modifications, as long as none of the modifications used in the combination contradict each other.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An image processing apparatus comprising:
a recording section that records information identifying diseases in association with polarization characteristics of disease positions having a disease;
an image acquiring section that acquires a polarized image captured at an observed position by an endoscope, the polarized image being captured using light having a plurality of different polarization states;
a determining section that determines the disease by comparing (i) the polarization characteristic of the observed position acquired from the polarized image to (ii) the polarization characteristics recorded in the recording section; and
a notification section that notifies a user with information specifying the disease determined by the determining section.

2. The image processing apparatus according to claim 1, wherein
the recording section records names of diseases in association with the polarization characteristics of the disease positions having the diseases,
the determining section determines the disease name by comparing (i) the polarization characteristic of the observed position acquired from the polarized image to (ii) the polarization characteristics recorded in the recording section, and
the notification section notifies the user of the disease name determined by the determining section.

3. The image processing apparatus according to claim 2, further comprising an irradiation angle detecting section that detects an irradiation angle relative to an irradiated surface at the observed position, which is irradiated with light, when the polarized image is captured, wherein
the recording section records irradiation angles relative to the irradiated surface, which is irradiated with light, when the polarization characteristics are obtained, in association with the polarization characteristics, and
the determining section determines the disease name by comparing (i) the polarization characteristic of the observed position acquired from the polarized image acquired by the image acquiring section to (ii) a polarization characteristic recorded in the recording section corresponding to an irradiation angle that sufficiently matches the irradiation angle acquired by the image acquiring section.

4. The image processing apparatus according to claim 2, further comprising a shape identifying section that identifies a shape of the observed position based on the polarized image acquired by the image acquiring section, wherein
the recording section records shapes of the diseased portions in association with the polarization characteristics of the diseased portions, and
the determining section determines the disease name by comparing (i) the polarization characteristic of the observed position acquired from the polarized image acquired by the image acquiring section to (ii) a polarization characteristic recorded in the recording section corresponding to a shape that sufficiently matches the shape identified by the shape identifying section.

5. The image processing apparatus according to claim 4, wherein
the image acquiring section acquires a polarized image that is captured using two types of returned light polarized orthogonally to each other, the two types of returned light obtained as a reflection of light irradiating the observed position, and
the shape identifying section identifies the shape of the observed position based on a ratio between the amount of each type of returned light, one type of returned light being polarized orthogonally to the other, in the polarized image acquired by the image acquiring section.

6. The image processing apparatus according to claim 5, wherein
the image acquiring section acquires a polarized image that is captured using two types of returned light polarized orthogonally to each other, the two types of returned light obtained as a reflection of polarized light irradiating the observed position.

7. The image processing apparatus according to claim 5, wherein
the image acquiring section further acquires an image that is captured using returned light obtained as a reflection of light diagonally irradiating the observed position, and
the shape identifying section identifies the shape based on the polarized image acquired by the image acquiring section and the image captured using returned light obtained as a reflection of the diagonally radiated light.

8. The image processing apparatus according to claim 5, wherein
the image acquiring section further acquires a polarized image that is captured using two types of returned light polarized orthogonally to each other, the two types of returned light obtained as a reflection of non-polarized light irradiating the observed position, and
the determining section compares (i) the polarization characteristic of the observed position acquired from the polarized image captured using the returned light obtained from the non-polarized light to (ii) the polarization characteristics recorded in the recording section.

9. The image processing apparatus according to claim 2, wherein
the polarization characteristics recorded in the recording section are polarized images, and
the determining section determines the disease name by comparing (i) the polarized image captured by the endoscope to (ii) the polarized images recorded in the recording section.

10. The image processing apparatus according to claim 1, further comprising an irradiation angle detecting section that detects an irradiation angle relative to an irradiated surface at the observed position, which is irradiated with light, when the polarized image is captured, wherein
the recording section records irradiation angles relative to the irradiated surface, which is irradiated with light, when the polarization characteristics are obtained, in association with the polarization characteristics, and
the determining section determines the disease by comparing (i) the polarization characteristic of the observed position acquired from the polarized image acquired by the image acquiring section to (ii) a polarization characteristic recorded in the recording section corresponding to an irradiation angle that sufficiently matches the irradiation angle acquired by the image acquiring section.

11. The image processing apparatus according to claim 1, further comprising a shape identifying section that identifies a shape of the observed position based on the polarized image acquired by the image acquiring section, wherein
the recording section records shapes of the diseased portions in association with the polarization characteristics of the diseased portions, and
the determining section determines the disease by comparing (i) the polarization characteristic of the observed position acquired from the polarized image acquired by the image acquiring section to (ii) a polarization characteristic recorded in the recording section corresponding to a shape that sufficiently matches the shape identified by the shape identifying section.

12. A system comprising:
the processing apparatus according to claim 1; and
an endoscope apparatus, wherein
the endoscope apparatus includes:
a first irradiating section that radiates light to the observed position; and
an image capturing section that captures an image using returned light obtained as a reflection of the light radiated by the first irradiating section, the returned light including light polarized in directions orthogonal to each other,
the image acquiring section acquires the polarized image captured by the image capturing section, and
the determining section determines the disease by comparing (i) the polarization characteristic of the observed position obtained from the polarized image to (ii) the polarization characteristics recorded in the recording section.

13. A method for image processing using a computer that is provided with a recording section that records information identifying diseases in association with polarization characteristics of disease positions having a disease, the method comprising:
acquiring a polarized image captured at an observed position by an endoscope, the polarized image being captured using light having a plurality of different polarization states;
determining the disease by comparing (i) the polarization characteristic of the observed position acquired from the polarized image to (ii) the polarization characteristics recorded in the recording section; and
notifying a user with information specifying the determined disease.

14. The method according to claim 13, wherein
the recording section records names of diseases in association with the polarization characteristics of the disease positions having the diseases,
determining the disease includes determining the disease name by comparing (i) the polarization characteristic of the observed position acquired from the polarized image to (ii) the polarization characteristics recorded in the recording section, and
notifying the user includes notifying the user of the determined disease name.

15. The method according to claim 14, further comprising detecting an irradiation angle relative to an irradiated surface at the observed position, which is irradiated with light, when the polarized image is captured, wherein
the recording section records irradiation angles relative to the irradiated surface, which is irradiated with light, when the polarization characteristics are obtained, in association with the polarization characteristics, and
determining the disease includes determining the disease name by comparing (i) the polarization characteristic of the observed position acquired from the acquired polarized image to (ii) a polarization characteristic recorded in the recording section corresponding to an irradiation angle that sufficiently matches the acquired irradiation angle.

16. The method according to claim 14, further comprising identifying a shape of the observed position based on the acquired polarized image, wherein
the recording section records shapes of the diseased portions in association with the polarization characteristics of the diseased portions, and
determining the disease includes determining the disease name by comparing (i) the polarization characteristic of the observed position acquired from the acquired polarized image to (ii) a polarization characteristic recorded in the recording section corresponding to a shape that sufficiently matches the identified shape.

17. A computer readable medium storing thereon a program for use by a computer provided with a recording section that records information identifying diseases in association with polarization characteristics of disease positions having a disease, the program, when executed, causing the computer to function as:
an image acquiring section that acquires a polarized image captured at an observed position by an endoscope, the polarized image being captured using light having a plurality of different polarization states;
a determining section that determines the disease by comparing (i) the polarization characteristic of the observed position acquired from the polarized image to (ii) the polarization characteristics recorded in the recording section; and
a notification section that notifies a user with information specifying the disease determined by the determining section.

18. The computer readable medium according to claim 17, wherein
the recording section records names of diseases in association with the polarization characteristics of the disease positions having the diseases,
the determining section determines the disease name by comparing (i) the polarization characteristic of the observed position acquired from the polarized image to (ii) the polarization characteristics recorded in the recording section, and
the notification section notifies the user of the disease name determined by the determining section.

19. The computer readable medium according to claim 18, wherein
the program further causes the computer to function as an irradiation angle detecting section that detects an irradiation angle relative to an irradiated surface, which is irradiated with light, when the polarized image is captured, wherein
he recording section records irradiation angles relative to the irradiated surface, which is irradiated with light, when the polarization characteristics are obtained, in association with the polarization characteristics, and
the determining section determines the disease name by comparing (i) the polarization characteristic of the observed position acquired from the polarized image acquired by the image acquiring section to (ii) a polarization characteristic recorded in the recording section corresponding to an irradiation angle that sufficiently matches the irradiation angle acquired by the image acquiring section.

20. The computer readable medium according to claim 18, wherein
the program further causes the computer to function as a shape identifying section that identifies a shape of the observed position based on the polarized image acquired by the image acquiring section, wherein
the recording section records shapes of the diseased portions in association with the polarization characteristics of the diseased portions, and
the determining section determines the disease name by comparing (i) the polarization characteristic of the observed position acquired from the polarized image acquired by the image acquiring section to (ii) a polarization characteristic recorded in the recording section corresponding to a shape that sufficiently matches the shape identified by the shape identifying section.
